(19) United States
(12) Patent Application Publication
(10) Pub. No.: US 2025/0326317 A1
(43) Pub. Date: Oct. 23, 2025

(54) SYSTEMS AND METHODS FOR COOPERATIVE DATA COMMUNICATIONS BY VEHICLES USING CHARGING STATIONS

(71) Applicant: Toyota Motor Engineering & Manufacturing North America, Inc., Plano, TX (US)

(72) Inventors: Chunghan Lee, Mountain View, CA (US); Seyhan Ucar, Mountain View, CA (US); Onur Altintas, Mountain View, CA (US); Kentaro Oguchi, Mountain View, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/640,101

(22) Filed: Apr. 19, 2024

(51) Int. Cl. B60L 53/66; B60L 53/62; B60L 53/67

(52) U.S. Cl. CPC B60L 53/66; B60L 53/62; B60L 53/67

(57) ABSTRACT

Systems, methods, and other embodiments described herein relate to cooperatively communicating through charging stations by vehicles splitting and offloading data. In one embodiment, a method includes acquiring information about a charge level and a transfer time for data that remains associated with a vehicle. The method also includes distributing the data by splitting into designated parts having part numbers and assigning the designated parts to the nearby vehicles according to collected parameters about the nearby vehicles upon estimating that the vehicle is overloaded with the data using the information and offloading to nearby vehicles is available. The method also includes communicating the part numbers to the nearby vehicles for transmitting the data during vehicle charging.

### TECHNICAL FIELD

The subject matter described herein relates, in general, to cooperatively communicating data by vehicles, and, more particularly, to cooperatively communicating through charging stations by vehicles offloading and distributing data.

### BACKGROUND

Vehicles having wireless connectivity to perform tasks and communicate data are rapidly growing. Vehicle-to-vehicle (V2V) is a protocol where one vehicle directly communicates data with one or more nearby vehicles. Vehicle manufacturers are building newer vehicles with expanded storage and bandwidth capabilities for entertainment and handling complex tasks such as automated driving with V2V. For example, an electric vehicle (EV) can upload a high-definition video using a high-speed cellular connection, a hotspot using Wi-Fi, etc. However, older and economical vehicles that are more prevalent on roads can have limited capabilities involving memory and data speeds that are demanded to access convenience, entertainment, and safety services. As such, vehicles encounter difficulties accessing data connections for enhanced and complex wireless services.

In various implementations, systems communicating data in a charging area supplying high-speed access points (AP) for EVs having multiple stations face difficulties with data overload. For example, voluminous data and frequent communication can be concentrated with an EV while other EVs are communicating regular traffic. This may form a bottleneck for the EV particularly when the charging time remaining at the charging area is limited. Here, the AP (e.g., a Wi-Fi AP) can have enough bandwidth but data communications go incomplete due to time spent at the charging area. Therefore, systems may misallocate resources that inhibit data communications at charging areas.

### SUMMARY

In one embodiment, example systems and methods relate to cooperatively communicating through charging stations by vehicles splitting and offloading data. In various implementations, systems manage communications and allocate resources between mobile devices to assist a source device using virtual networks and connection overload. For example, a system creates and destroys a virtual network on the same physical network for managing communications that are offloaded from a source vehicle to other vehicles. The system may also manage resources for an enhanced wireless network (e.g., a satellite network) for assisting the source device with completing a communication when capabilities such as data speeds are limited. Nevertheless, vehicles and other mobile devices encounter transmission bottlenecks and errors due to lacking connectivity and access management. Thus, systems that allocate and distribute resources for vehicle communication are demanded, particularly for tasks that are data intensive such as automated driving, mobile entertainment, etc.

Therefore, in one embodiment, a management system cooperatively communicates data through a distribution scheme and offloading according to a charge level and transfer time for the data. In one approach, a vehicle having advanced communication capabilities acquires the data from a vehicle having communication capabilities that are basic through vehicle-to-vehicle (V2V) communications. The management system distributes the data from the vehicle (e.g., an electric vehicle, a hybrid-EV, a plug-in HEV, an internal combustion engine (ICE) vehicle, etc.) when overloaded to nearby vehicles during charging using a network (e.g., a local area network (LAN), a wireless LAN (WLAN), etc.) in an area having a charging station(s). In particular, the management system identifies using a databroker that the vehicle is overloaded with the data (e.g., upload data) and unable to completely transfer the data during the charging. Here, the databroker may operate within a server, charging stations within an area, the nearby vehicles, etc., formulate the distribution scheme using states about the nearby vehicles, and send instructions to transfer the data accordingly. For instance, the distribution scheme involves splitting the data into designated parts having part numbers and assigning the designated parts to nearby vehicles. In this way, the management system coordinates data transfers that avoid bottlenecks and completes communications, thereby improving efficiency and system robustness.

In various implementations, the management system distributes the data according to a charging rate and upload time remaining for the vehicle and the nearby vehicles using Wi-Fi, Wi-Fi direct, a V2V connection, etc. Here, parameters about the nearby vehicles indicate that assistance is available since charge levels and data transfer times remaining are at a reduced point. As such, the management system can communicate the part numbers associated with the designated parts for the vehicle to the nearby vehicles that transmit the designated parts while charging and transferring other data. Accordingly, the management system coordinates data transfers at an area having charging stations through distribution and data splitting that improves resource allocation through offloading.

In one embodiment, a management system for cooperatively communicating through charging stations by vehicles splitting and offloading data is disclosed. The management system includes a memory including instructions that, when executed by a processor, cause the processor to acquire information about a charge level and a transfer time for data that remains associated with a vehicle. The instructions also include instructions to distribute the data by splitting into designated parts having part numbers and assigning the designated parts to the nearby vehicles according to collected parameters about the nearby vehicles upon an estimate that the vehicle is overloaded with the data using the information and offloading to nearby vehicles is available. The instructions also include instructions to communicate the part numbers to the nearby vehicles for transmitting the data during vehicle charging.

In one embodiment, a non-transitory computer-readable medium for cooperatively communicating through charging stations by vehicles splitting and offloading data and including instructions that when executed by a processor cause the processor to perform one or more functions is disclosed. The instructions include instructions to acquire information about a charge level and a transfer time for data that remains associated with a vehicle. The instructions also include instructions to distribute the data by splitting into designated parts having part numbers and assigning the designated parts to the nearby vehicles according to collected parameters about the nearby vehicles upon an estimate that the vehicle is overloaded with the data using the information and offloading to nearby vehicles is available. The instructions also include instructions to communicate the part numbers to the nearby vehicles for transmitting the data during vehicle charging.

In one embodiment, a method for cooperatively communicating through charging stations by vehicles splitting and offloading data is disclosed. In one embodiment, the method includes acquiring information about a charge level and a transfer time for data that remains associated with a vehicle. The method also includes distributing the data by splitting into designated parts having part numbers and assigning the designated parts to the nearby vehicles according to collected parameters about the nearby vehicles upon estimating that the vehicle is overloaded with the data using the information and offloading to nearby vehicles is available. The method also includes communicating the part numbers to the nearby vehicles for transmitting the data during vehicle charging.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a management system that is associated with offloading and distributing data transfers within an area having a charging station(s).

FIGS. 3A and 3B illustrate embodiments of advanced vehicles supporting another vehicle overloaded with a data transfer using wireless communications and splitting data during charging.

FIG. 4 illustrates an example of managing data transfers and privacy involving vehicles in an area having charging stations.

FIGS. 5A and 5B illustrate embodiments of splitting data from a vehicle with nearby vehicles according to a charge level and a transfer time remaining for the data.

FIGS. 6A and 6B illustrate embodiments of transferring data using a policy when offloading to nearby vehicles is unavailable.

FIG. 7 illustrates one embodiment of a method that is associated with distributing data through splitting by estimating that a vehicle is overloaded with data and offloading to nearby vehicles having transfer availability.

### DETAILED DESCRIPTION

Systems, methods, and other embodiments associated with cooperatively communicating data (e.g., uploads) through a distribution scheme and offloading according to a charge level and transfer time for the data are disclosed herein. In various implementations, vehicles communicate data using an area having charging stations providing a network (e.g., a local area network (LAN), a wireless LAN (WLAN), etc.) through access points (AP). The APs can have wired connections that transmit at increased speeds compared to cellular connections. However, a vehicle having voluminous data can be unable to complete a data transfer directly during a charging event (e.g., 20-30 minutes) or while traveling through the area depending upon data sizes. Furthermore, charging stations may lack memory to store data for managing data transfers, such as due to security risks encountered when other vehicle vendors and third parties use the charging stations. In one approach, systems create virtual networks on-demand with a network for Internet of Things (IoT) devices for managing data loads while maintaining sufficient data security. Other systems can implement a graph neural network (GNN) that creates and destroys multiple virtual networks with minimum end-to-end (E2E) latency on a network. Nevertheless, these systems are deficient at maximizing throughput and mitigating data overload at a vehicle.

Therefore, in one embodiment, a management system splits and distributes data among nearby vehicles when a vehicle is estimated as being overloaded with the data and offloading is an available option. For example, the vehicle is overloaded when having a state of charge (SOC) and a remaining time for a data transfer at elevated points. As such, the overload is mitigated through distribution that can involve splitting the data into designated parts having part numbers and the designated parts are subsequently assigned to the nearby vehicles. In particular, the distribution mitigates the overload at the vehicle by allocating and transmitting the designated parts according to data loads and charging states of the nearby vehicles. In one approach, an entity within the management system includes a databroker having a state collector that includes data about states of charge (SOCs) and data transfers remaining for the vehicle and the nearby vehicles. A component of the state collector assigns the designated parts and the management system allocates the designated parts according to the SOCs and the data transfers of the nearby vehicles. In this way, the management system balances loads and efficiently allocates resources so that an overload at a vehicle is averted.

In various implementations, the management system includes alternatives to transferring voluminous data through planning and distributing among nearby vehicles using a policy when offloading is otherwise unavailable. For instance, the management system uploads the voluminous data according to a designated policy that specifies using a cellular network, uploading during the next charging time, etc. when an offloading option is absent. Here, the nearby vehicles may be fully charged, time remaining for data transfers by nearby vehicles may be limited, etc. Accordingly, the management system distributes data from an overloaded vehicle when offloading is available and otherwise fallbacks to a policy, thereby allowing a robust system that increases efficiencies and averts slowdowns for data transfers among vehicles.

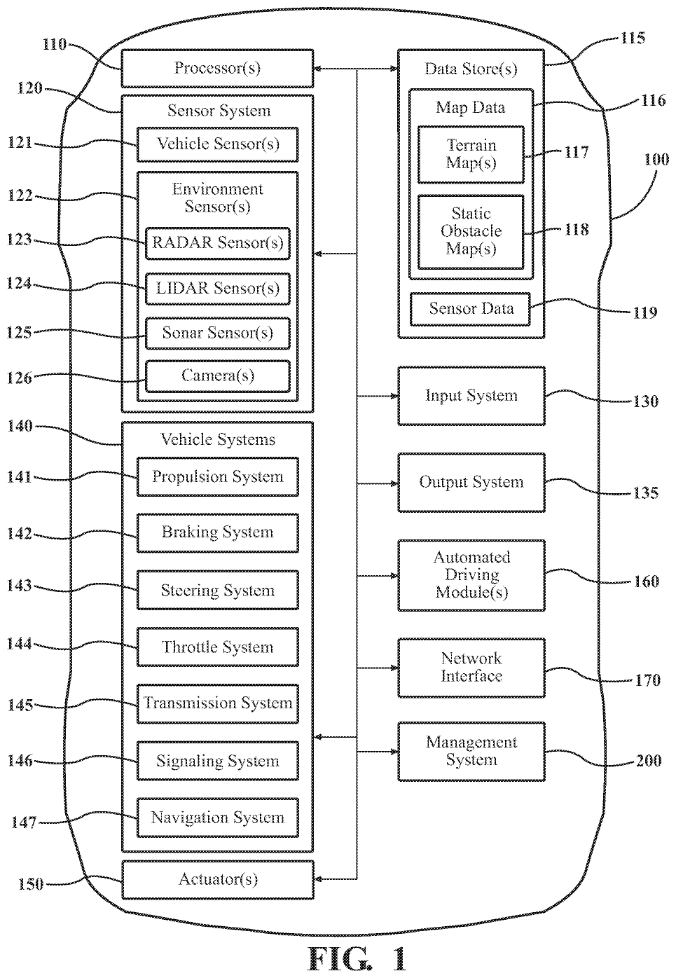

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, a management system 200 uses road-side units (RSU), consumer electronics (CE), mobile devices, robots, drones, and so on that benefit from the functionality discussed herein associated with cooperatively communicating data through a distribution scheme and offloading according to a charge level and transfer time for the data.

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances. For example, as discussed, one or more components of the disclosed system can be implemented within a vehicle while further components of the system are implemented within a cloud-computing environment or other system that is remote from the vehicle 100.

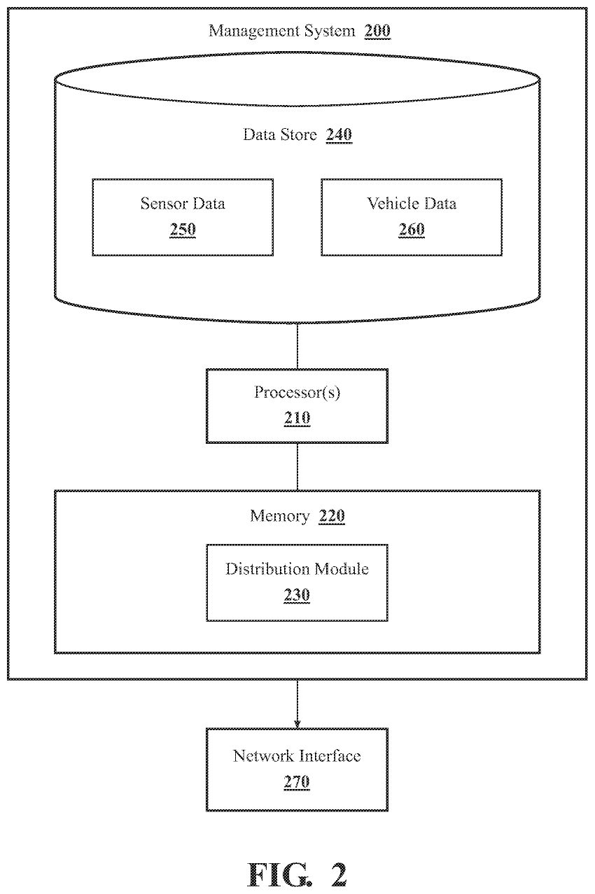

Some of the possible elements of the vehicle 100 are shown in FIG. 1 and will be described along with subsequent figures. However, a description of many of the elements in FIG. 1 will be provided after the discussion of FIGS. 2-7 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 can include the management system 200 that is implemented to perform methods and other functions as disclosed herein relating to cooperatively communicating data through a distribution scheme and offloading according to a charge level and transfer time for the data. As will be discussed in greater detail subsequently, the management system 200, in various embodiments, can also be implemented on one or more charging stations, one or more vehicles, a server, as a cloud-based service, etc. Furthermore, in one approach, functionality associated with at least one module of the management system 200 is implemented within the vehicle 100 while further functionality is implemented within a cloud-based computing system.

With reference to FIG. 2, one embodiment of the management system 200 is further illustrated. In one embodiment, the management system 200 includes a processor 210 and memory 220 that stores the distribution module 230. The memory 220 is a random-access memory (RAM), a read-only memory (ROM), a hard-disk drive, a flash memory, or other suitable memory for storing the distribution module 230. The distribution module 230 is, for example, computer-readable instructions that when executed by the processor(s) 210 cause the processor(s) 210 to perform the various functions disclosed herein.

The management system 200 as illustrated in FIG. 2 is generally an abstracted form. Furthermore, the distribution module 230 generally includes instructions that function to control the processor(s) 210 to receive data inputs from one or more sensors of the vehicle 100. The inputs are, in one embodiment, observations of one or more objects in an environment proximate to the vehicle 100 and/or other aspects about the surroundings. As provided for herein, the management system 200, in one embodiment, acquires sensor data 250 that includes at least camera images. In further arrangements, the management system 200 acquires the sensor data 250 from further sensors such as radar sensors 123, LIDAR sensors 124, and other sensors as may be suitable for identifying vehicles and locations of the vehicles.

Accordingly, the management system 200, in one embodiment, controls the respective sensors to provide the data inputs in the form of the sensor data 250. Additionally, while the management system 200 is discussed as controlling the various sensors to provide the sensor data 250, in one or more embodiments, the management system 200 can employ other techniques to acquire the sensor data 250 that are either active or passive. Moreover, the management system 200 can undertake various approaches to fuse data from multiple sensors when providing the sensor data 250 and/or from sensor data acquired over a wireless communication link. Thus, the sensor data 250, in one embodiment, represents a combination of perceptions acquired from multiple sensors.

Moreover, in one embodiment, the management system 200 includes a data store 240. In one embodiment, the data store 240 is a database. The database is, in one embodiment, an electronic data structure stored in the memory 220 or another data store and that is configured with routines that can be executed by the processor(s) 210 for analyzing stored data, providing stored data, organizing stored data, and so on. Thus, in one embodiment, the data store 240 stores data used by the distribution module 230 in executing various functions. In one embodiment, the data store 240 includes the sensor data 250 along with, for example, metadata that characterize various aspects of the sensor data 250. For example, the metadata can include location coordinates (e.g., longitude and latitude), relative map coordinates or tile identifiers, time/date stamps from when the separate sensor data 250 was generated, and so on. In one embodiment, the data store 240 further includes the vehicle data 260 having parameters about a charge level (e.g., SOC) and a transfer time for data that remains associated with the vehicle 100 acquired over network interface 270. The parameters can also include states of charges (SOC) and data transfers remaining for vehicles nearby an area having charging stations that include data transfer capabilities.

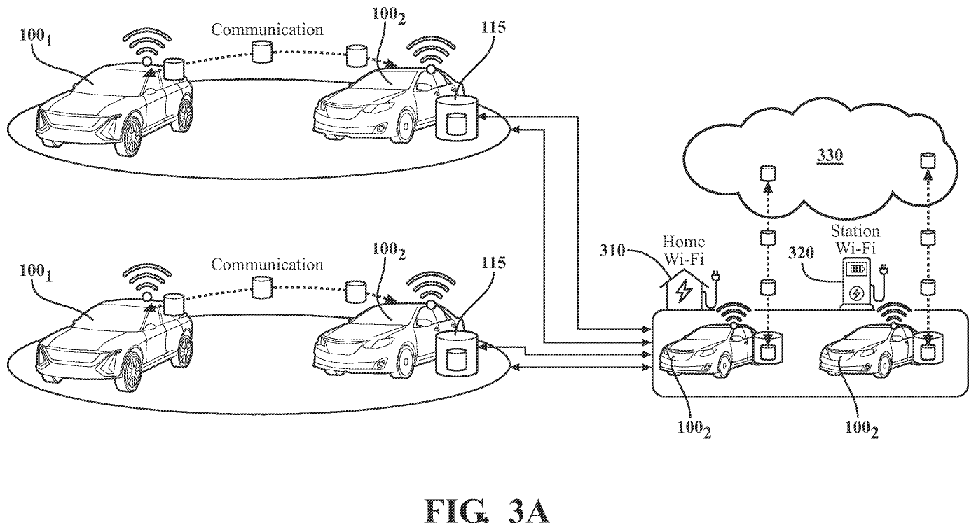

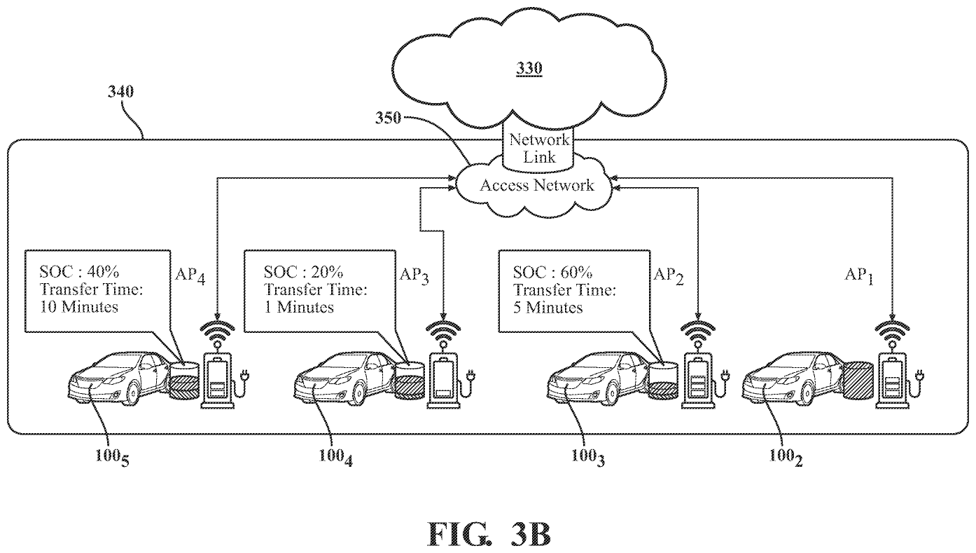

Now turning to FIGS. 3A and 3B, embodiments of advanced vehicles supporting another vehicle overloaded with a data transfer using wireless communications and splitting data during charging are illustrated. Here, in one embodiment, the management system 200 is further configured to perform additional tasks beyond controlling the respective sensors to acquire and provide the sensor data 250. For example, the management system 200 and the distribution module 230 includes instructions that cause the processor 210 to receive data by the vehicle 100₂ from another vehicle 100₁ having communication capabilities that are limited using a vehicle-to-vehicle (V2V) connection and the vehicle 100₁ has connection speeds that are sufficient for transmitting the data. For example, the vehicle 100₁ is an internal combustion engine (ICE) vehicle having third generation (3G) and 802.11n connectivity and limited memory. On the other hand, the vehicle 100₂ has enhanced capabilities such as 5G and Institute of Electrical and Electronics Engineers (IEEE) 802.11be connectivity for communications over network interface 170 and ample memory. Furthermore, in one embodiment, the vehicles 100₁ and 100₂ can be hybrid electric vehicles (HEV), EVs, plug-in HEVs (PHEV), etc. As such, the vehicle 100₂ can assist the vehicle 100₁ with data transfers at elevated speeds by mimicking an access point (AP) and acquiring the data for transfer over the network 330 during charging using home Wi-Fi 310, station Wi-Fi 320, etc.

In FIG. 3B, the vehicle 100₂ can arrive to the area 340 for charging, data connectivity, etc. The area 340 also includes vehicles 100₃-100₅ charging through multiple charging stations supplying data connectivity through the access network 350. Here, the charging stations include access point 1 (AP₁) to AP₄, such as a 802.11, Wi-Fi, etc., AP. For example, the access network 350 and AP₁-AP₄ implement transmission control protocol/internet protocol (TCP/IP) for transferring data from vehicles 100₂-100₅ to the network 330 using the network interface 170. In various implementations, the vehicle 100₂ is overloaded with local and acquired data from other vehicles, such as the vehicle 100₁. Furthermore, the management system 200 can estimate an overload for the vehicle 100₂ according to a charge level and a transfer time for the local and acquired data using information transferred with the network interface 270. As explained below, reducing the overload can involve collecting parameters about the vehicles 100₃-100₅ reflecting an offloading state that is available. A scheme distributing the local and acquired data can factor the offloading states of other vehicles. For instance, the management system 200 acquires information that the vehicle 100₃ can supply some offloading as charging time within the area 340 is limited with a transfer time remaining at five minutes and a SOC at 60%. However, the vehicle 100₄ will spend more time at the area 340 having a SOC at 20% and a transfer time remaining of one minute, thereby being available for more assistance with offloading data from the vehicle 100₂. Regarding the vehicle 100₅, a SOC at 40% and a transfer time of ten minutes remaining also indicate availability for assisting with offloading data from the vehicle 100₂.

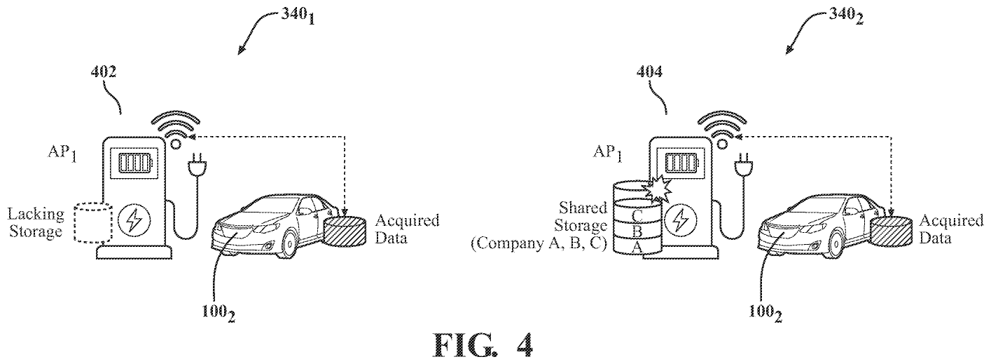

Concerning FIG. 4, an example of managing data transfers and privacy involving vehicles in an area having charging stations is illustrated. Here, data transfer 402 involves the vehicle 100₂ arriving at the AP₁ with acquired data from the vehicle 100₁. The data transfer 402 within the area 3401 maintains privacy for the acquired data by lacking storage at AP₁ and keeping the acquired data primarily on the vehicle 100₁. In the area 3402, privacy can be jeopardized with the AP₁ sharing storage for data from vehicle company A, vehicle company B, vehicle company C, etc. during data transfer 404. Therefore, in one approach, the management system 200 splits and distributes the acquired data within the area 340 without sharing storage among multiple vehicle companies, manufacturers, and original equipment makers (OEM), thereby improving data privacy.

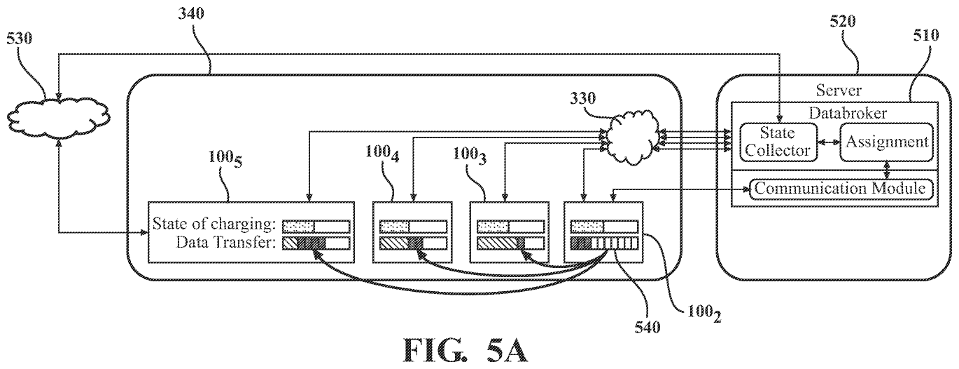

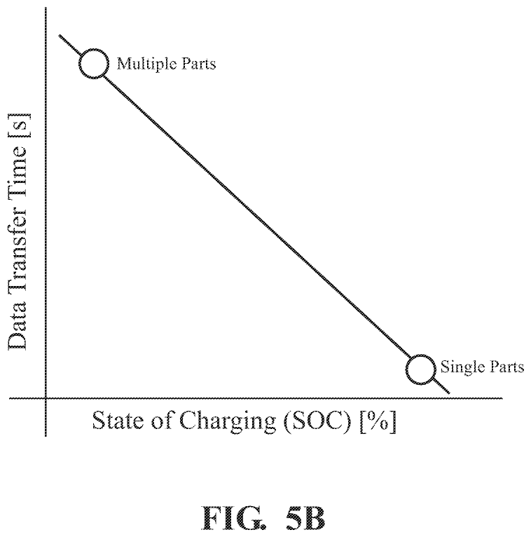

Regarding FIGS. 5A and 5B, embodiments of splitting data from the vehicle 100₂ with nearby vehicles according to a charge level and a transfer time remaining for the data are illustrated. Here, the charging area 340 communicates with a databroker 510 implemented at a server 520 for assisting with data offloading and splitting. The databroker 510 can compute whether the vehicle 100₂ is overloaded and offloading is a viable option. Although the databroker 510 is illustrated as being implemented at the server 520, in one approach, the databroker 510 can be located at one or more of charging stations within the area 340 and the vehicles 100₂-100₅ nearby the area 340. Furthermore, the server 520 can be co-located with the charging stations associated with splitting and distributing data among the vehicles 100₃-100₅, thereby reducing communication lag and latency through geographic proximity.

In one approach, the server 520 plans and instructs the vehicles 100₂-100₅ to acquire data 540 from another vehicle by splitting into designated parts having part numbers. The designated parts can be assigned to the vehicles 100₃-100₅ nearby according to collected parameters about the vehicles 100₂-100₅. For example, a state collector within the databroker 510 acquires SOCs and upload times remaining for the vehicles 100₃-100₅ directly over the network 330. Furthermore, the databroker 510 acquires the parameters about the vehicles 100₃-100₅ from a cloud computer 530 that gathers vehicle states, a number of vehicles charging, etc.

In FIG. 5A, the vehicles 100₃-100₅ can have local data along with the acquired data 540 for transfer over the network 330 similar to the vehicle 100₂. An assignment component within the databroker factors the local data for splitting the acquired data 540 stored on the vehicle(s) 100₂-100₅. In one approach, the management system 200 estimates that the vehicle 100₂ is overloaded with transferring the acquired data 540 using a charge level and a transfer time about the vehicle 100₂. As such, the acquired data 540 is split and formed into multiple parts if the SOC is low and the upload time remaining is high. For example, the assignment logic distributes the acquired data 540 by splitting into ten designated parts having part numbers and assigning the ten designated parts to the vehicles 100₂-100₅.

In various implementations, the assignment component within the databroker 510 analyzes SOCs and times remaining for data transfers of nearby vehicles 100₃-100₅ and allocates the designated parts accordingly. For example, the assignment component allocates one part to the vehicle 100₃ when having a SOC at a lower amount while time for data transfer remaining is at a higher amount. Meanwhile, the vehicle 100₄ is allocated two parts when having a SOC and a time for a data transfer remaining at an average amount (e.g., 40%). Furthermore, the vehicle 100₅ is allocated four parts when having a SOC that is average and time for data transfer remaining is at a lower amount. In this way, the management system 200 can balance data allocation and optimize resources by the vehicle 100₂ transmitting the remaining three parts.

Additionally, the management system 200 coordinates data transfers between charging stations having connectivity in an area and the databroker 510. Here, the charging stations include network connections (e.g., a LAN, a WLAN, etc.) with the nearby vehicles and the databroker 510 can manage the distribution of the acquired data 540 by the vehicle 100₂ according to a status associated with the charging stations. The databroker 510 can also factor a charge level and transfer time remaining for the vehicle 100₂ to estimate an overload condition and coordinate the distribution, such as using a V2V connection. Upon completing offloading assessments and assignments, the management system 200 communicates the part numbers and related parts of the acquired data 540 for cooperative transmission by the vehicles 100₃-100₅ during charging.

Additional details about the relationship between SOC and time for data transfer remaining are illustrated by FIG. 5B. Here, the management system 200 may split acquired data into multiple parts when the data transfer time remaining is at a higher amount and the SOC is at a lower amount. In this case, the vehicle 100 may have insufficient time to complete the data transfer during charging. However, a databroker may instruct the vehicle 100 to transmit the data in a single part when SOC is at a higher amount and a data transfer time remaining is at a lower amount. Although FIG. 5B illustrates a linear relationship estimated between SOC and time for data transfer remaining, the relationship can exhibit other curve forms (e.g., quadratic, exponential, etc.), such as depending upon vehicle, charging station, and data types.

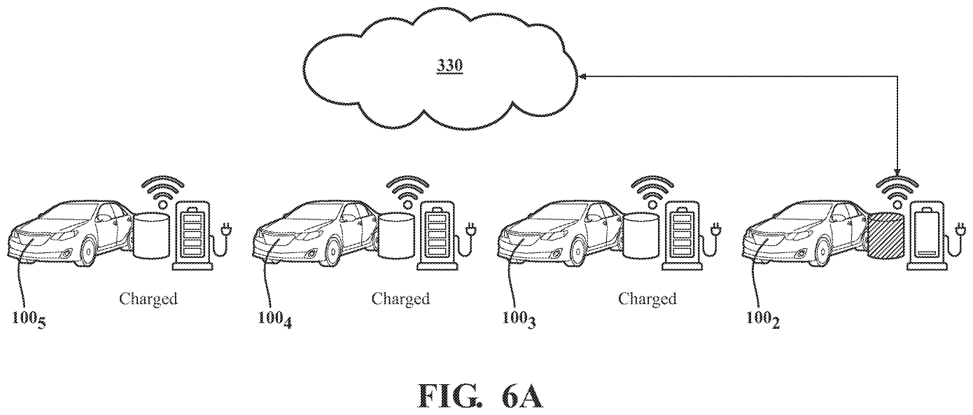

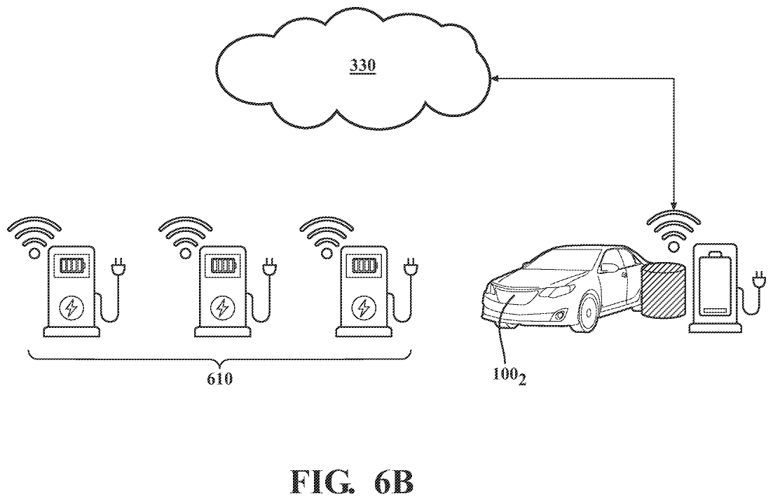

Focusing on FIGS. 6A and 6B, embodiments of transferring data using a policy when offloading to nearby vehicles are unavailable are illustrated. In FIG. 6A, the vehicle 100₂ arrives at an area having multiple charging stations including AP connectivity and data acquired from the vehicle 100₁. The vehicle 100₂ is overloaded since a data transfer of the data would be incomplete within the charging time remaining for reaching a complete SOC. For example, the vehicle 100₂ has a charge level at a lower amount and a transfer time at a higher amount. However, in this case, offloading is unavailable since the vehicles 100₃-100₅ are at full SOCs, lack upload time remaining, etc., thereby likely departing shortly from the area. Similarly, FIG. 6B illustrates the vehicle 100₂ that is overloaded with data acquired from the vehicle 100₁ arriving at an area having multiple charging stations 610 with AP connectivity. Here, the vehicle 100₂ cannot offload acquired data since the charging stations 610 lack vehicles that are charging. Accordingly, in one approach, the vehicle 100₂ transfers the acquired data using a scheme including policies.

Concerning approaches for the management system 200 transferring the acquired data using the policy, the vehicle 100₂ can re-distribute the acquired data to nearby vehicles during a subsequent charging time. For example, the vehicle 100₂ communicates a portion of the acquired data by the nearby vehicles using a LAN, WLAN, etc. located at a charging station and the data remaining during another charging event. As another policy, the vehicle 100₂ may communicate the acquired data directly during a next charging event if an overload condition is unmet and nearby vehicles are unavailable. Furthermore, communicating the acquired data by the vehicle 100₂ via a mobile network (e.g., 5G data) may also be a policy.

In various implementations, the distribution scheme in FIG. 5A and the policy-based approach in FIG. 6A factor a priority level to communicate acquired data. For instance, the management system 200 distributes acquired data received from another vehicle according to accident parameters, a variable associated with abnormal behavior, a target application, batching parameters, and so on. Here, a priority level that is elevated can be for accident parameters, a variable associated with abnormal behavior (e.g., swerving, speeding, etc.), a target application (e.g., automated driving), etc. Reduced priority levels can be assigned for entertainment data, batch processing, etc. Accordingly, the management system 200 can optimize data transfers and improve safety involving vehicles through factoring priority levels associated with the acquired data.

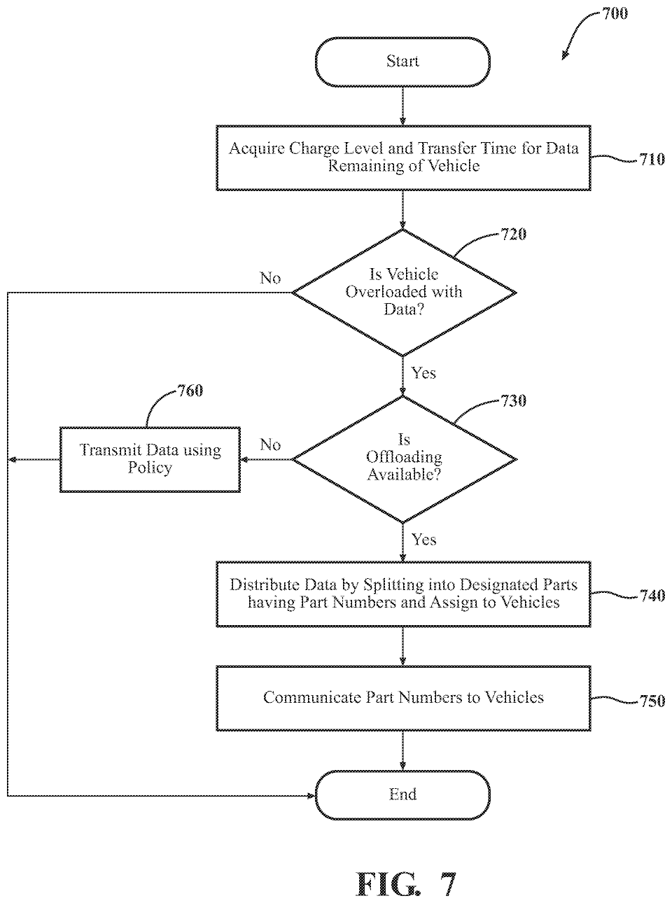

Now turning to FIG. 7, a flowchart of a method 700 that is associated with distributing data through splitting by estimating that a vehicle is overloaded with data and offloading to nearby vehicles when available is illustrated. Method 700 will be discussed from the perspective of the management system 200 of FIG. 2. While the method 700 is discussed in combination with the management system 200, it should be appreciated that the method 700 is not limited to being implemented within the management system 200 but is instead one example of a system that may implement the method 700.

At 710, the management system 200 acquires a charge level and transfer time for data remaining of a vehicle 100. Here, the vehicle 100 can receive the data from another vehicle having communication capabilities that are limited while the vehicle 100 has connection speeds that are sufficient for transmitting the data. For instance, the another vehicle is an ICE vehicle having third generation connectivity, limited memory, etc. for communicating the data rapidly and efficiently. On the contrary, the vehicle 100 has enhanced capabilities such as 5G connectivity, vast memory, etc. As such, the vehicle 100 can assist the another vehicle with data transfers by acquiring the data and transferring the data during charging using home Wi-Fi, station Wi-Fi, etc. Furthermore, the scenario in 710 can involve the vehicle 100 arriving to an area that includes other vehicles charging through multiple charging stations. Here, the charging stations can supply data connectivity through an access network having one or more APs, (e.g., a 802.11, Wi-Fi, etc. AP).

At 720, the management system 200 estimates whether the vehicle 100 is overloaded with local and acquired data from other vehicles. For example, the management system 200 can estimate the overload according to a charge level and a transfer time remaining for the local and acquired data. This may involve a databroker implemented at one of a server, one or more charging stations within the area, and multiple vehicles nearby the area computing that the vehicle 100 will be unable to completely transfer the acquired data according to the charge level and the transfer time remaining. As previously explained, in one embodiment, a transfer may go incomplete if the SOC is low and the upload time remaining is high for the vehicle 100. Conversely, the vehicle 100 can transmit the acquired data in a single part when SOC is at a higher amount level and a data transfer time remaining is at a lower amount, thereby ending the method 700.

At 730, the management system 200 computes whether offloading the acquired data from the vehicle 100 to other vehicles is available. For example, the databroker collects parameters about the other vehicles and calculates offloading metrics and states for distributing the acquired data. In this way, one or more of the other vehicles may be deemed readily available when both a SOC and a transfer time remaining are very limited. As previously explained, assistance may also be available when SOC and transfer time remaining are both at a balanced level, a similar level, etc.

At 740, the distribution module 230 distributes the acquired data by splitting into designated parts having part numbers and assigns the designated parts to the other vehicle(s) when the vehicle 100 is overloaded and offloading is available. For instance, the distribution module 230 splits the acquired data into x designated parts having part numbers. A scheme for the distribution may be formed through analyzing SOCs and times remaining for data transfers of the other vehicles. Here, a minimal number of designated parts can be assigned to a nearby vehicle charging that has a SOC at a lower amount while time for data transfer remaining is at a higher amount. Conversely, a nearby vehicle charging is allocated up to half the designated parts when having a SOC that is average and time for data transfer remaining is at a lower amount. As an additional enhancement, the distribution module 230 may compute a reduced size for the designated parts when the charge level is at a higher amount and the transfer time is limited. In one approach, the number of parts, part sizes, etc. may be associated with a linear relationship estimated between SOC and time for data transfer remaining. As previously explained, the relationship can also take different curve forms (e.g., quadratic, exponential, etc.) that depend upon one of vehicle, charging station, and data types.

At 750, the management system 200 communicates part numbers to other vehicles nearby that are charging in an area having one or more charging stations. Upon completing the assignment, the vehicle 100 sends the designated parts for transmission using a network (e.g., wireless, wired, etc.) WLAN, LAN, direct connection (e.g., cellular-to-cellular), etc. to the other vehicles(s) for transmission during charging. In this way, the management system 200 optimizes resources and avoids bottlenecks by splitting the acquired data into designated parts and distributing the designated parts to the other vehicles for offloading and transmission.

At 760, the management system 200 transmits the acquired data according to policy when offloading to the other vehicles is unavailable. For example, offloading is unavailable since the other vehicles have full SOCs, lack upload time remaining, etc., thereby likely to soon depart from the area. In one approach, the vehicle 100 is unable to offload the acquired data because an area lacks vehicles that are charging, connected, etc. In these cases, the vehicle 100 can re-distribute the acquired data to nearby vehicles during a subsequent charging time. As another policy, the vehicle 100 communicates the acquired data directly during a next charging event if an overload condition is unmet and nearby vehicles are unavailable. Furthermore, the vehicle 100 can communicate the acquired data via a mobile network (e.g., 5G data) as a policy. Accordingly, the management system 200 coordinates and distributes acquired data from an overloaded vehicle to other vehicles in a charging area through splitting into parts and otherwise follows a policy to transmit the acquired data, thereby improving efficiency and robustness for data transfers.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., category 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, programmable read-only memory (PROM), erasable programmable read-only memory (EPROM), electrically erasable programmable read-only memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate to the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or one or more cameras 126. In one or more arrangements, the one or more cameras 126 can be high dynamic range (HDR) cameras, stereo, or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include an output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110 and/or the automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the movement of the vehicle 100. The processor(s) 110 and/or the automated driving module(s) 160 may control some or all of the vehicle systems 140 and, thus, may be partially or fully autonomous as defined by the society of automotive engineers (SAE) levels 0 to 5.

The processor(s) 110 and/or the automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the movement of the vehicle 100. The processor(s) 110 and/or the automated driving module(s) 160 may control some or all of the vehicle systems 140.

The processor(s) 110 and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110 and/or the automated driving module(s) 160 can control the direction and/or speed of the vehicle 100. The processor(s) 110 and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 119. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-7, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a LAN or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A management system comprising:
a memory storing instructions that, when executed by a processor, cause the processor to:
acquire information about a charge level and a transfer time for data that remains associated with a vehicle;
upon an estimate that the vehicle is overloaded with the data using the information and offloading to nearby vehicles is available, distribute the data by splitting into designated parts having part numbers and assigning the designated parts to the nearby vehicles according to collected parameters about the nearby vehicles; and
communicate the part numbers to the nearby vehicles for transmitting the data during vehicle charging.

2. The management system of claim 1, wherein the instructions to distribute the data by splitting into the designated parts and assigning the designated parts further includes instructions to:
analyze states of charges (SOC) and data transfers remaining for the nearby vehicles by one of a server, charging stations within an area, and the nearby vehicles having a databroker, wherein the databroker includes a state collector about the vehicle and the nearby vehicles and a component that assigns the designated parts; and
allocate the designated parts to the nearby vehicles according to the SOCs and the data transfers.

3. The management system of claim 1, wherein the instructions to estimate that the vehicle is overloaded with the data using the information and offloading to the nearby vehicles further includes instructions to:
coordinate between charging stations in an area having a databroker and the charging stations including communications with the nearby vehicles, wherein the databroker manages distribution of the data according to the information and status associated with the charging stations.

4. The management system of claim 1, wherein the instructions to estimate that the vehicle is overloaded with the data further includes instructions to:
calculate for the information that the charge level is at a reduced point and the transfer time is at an elevated point; and
transfer the data using a policy when offloading to the nearby vehicles is unavailable by factoring the information.

5. The management system of claim 4, wherein the policy includes one of:
re-distributing the data to the nearby vehicles during a subsequent charging time for the vehicle;
communicating the data during a charging event upcoming for the vehicle;
communicating the data by the vehicle via a mobile network; and
communicating a portion of the data by the nearby vehicles using a communication channel at a charging station within an area.

6. The management system of claim 1, wherein the instructions to estimate that the vehicle is overloaded with the data and communicate the part numbers further includes instructions to:
compute a reduced size for the designated parts when the charge level is at an elevated point and the transfer time is limited; and
send the designated parts for transmission using a communication channel supplied by a charging station within an area.

7. The management system of claim 1, wherein the instructions to estimate that the vehicle is overloaded with the data further includes instructions to:
distribute the data by splitting into the designated parts according to a priority level, wherein the priority level factors one of accident parameters, a variable associated with abnormal behavior, a target application, and batching parameters.

8. The management system of claim 1 further including instructions to:
receive the data by the vehicle from another vehicle having communication capabilities that are limited using a vehicle-to-vehicle (V2V) connection, wherein the vehicle has connection speeds that are sufficient for transmitting the data; and
upload the data by the vehicle at a charging station according to the part numbers and the designated parts.

9. The management system of claim 1, wherein the instructions to distribute the data by splitting into the designated parts and assigning the designated parts further includes instructions to:
form the designated parts by the vehicle using the information and directions from a databroker, where the directions factor states of charges (SOC) and remaining data transfers for the nearby vehicles accumulated by the databroker.

10. A non-transitory computer-readable medium comprising:
instructions that when executed by a processor cause the processor to:
acquire information about a charge level and a transfer time for data that remains associated with a vehicle;
upon an estimate that the vehicle is overloaded with the data using the information and offloading to nearby vehicles is available, distribute the data by splitting into designated parts having part numbers and assigning the designated parts to the nearby vehicles according to collected parameters about the nearby vehicles; and
communicate the part numbers to the nearby vehicles for transmitting the data during vehicle charging.

11. The non-transitory computer-readable medium of claim 10, wherein the instructions to distribute the data by splitting into the designated parts and assigning the designated parts further includes instructions to:
analyze states of charges (SOC) and data transfers remaining for the nearby vehicles by one of a server, charging stations within an area, and the nearby vehicles having a databroker, wherein the databroker includes a state collector about the vehicle and the nearby vehicles and a component that assigns the designated parts; and
allocate the designated parts to the nearby vehicles according to the SOCs and the data transfers.

12. A method comprising:
acquiring information about a charge level and a transfer time for data that remains associated with a vehicle;
upon estimating that the vehicle is overloaded with the data using the information and offloading to nearby vehicles is available, distributing the data by splitting into designated parts having part numbers and assigning the designated parts to the nearby vehicles according to collected parameters about the nearby vehicles; and
communicating the part numbers to the nearby vehicles for transmitting the data during vehicle charging.

13. The method of claim 12, wherein distributing the data by splitting into the designated parts and assigning the designated parts further includes:
analyzing states of charges (SOC) and data transfers remaining for the nearby vehicles by one of a server, charging stations within an area, and the nearby vehicles having a databroker, wherein the databroker includes a state collector about the vehicle and the nearby vehicles and a component that assigns the designated parts; and
allocating the designated parts to the nearby vehicles according to the SOCs and the data transfers.

14. The method of claim 12, wherein estimating that the vehicle is overloaded with the data using the information and offloading to the nearby vehicles further includes:
coordinating between charging stations in an area having a databroker and the charging stations including communications with the nearby vehicles, wherein the databroker manages distribution of the data according to the information and status associated with the charging stations.

15. The method of claim 12, wherein estimating that the vehicle is overloaded with the data further includes:
calculating for the information that the charge level is at a reduced point and the transfer time is at an elevated point; and
transferring the data using a policy when offloading to the nearby vehicles is unavailable by factoring the information.

16. The method of claim 15, wherein the policy includes one of:
re-distributing the data to the nearby vehicles during a subsequent charging time for the vehicle;
communicating the data during a charging event upcoming for the vehicle;
communicating the data by the vehicle via a mobile network; and
communicating a portion of the data by the nearby vehicles using a communication channel at a charging station within an area.

17. The method of claim 12, wherein estimating that the vehicle is overloaded with the data and communicating the part numbers further includes:
computing a reduced size for the designated parts when the charge level is at an elevated point and the transfer time is limited; and
sending the designated parts for transmission using a communication channel supplied by a charging station within an area.

18. The method of claim 12, wherein estimating that the vehicle is overloaded with the data further includes:
distributing the data by splitting into the designated parts according to a priority level, wherein the priority level factors one of accident parameters, a variable associated with abnormal behavior, a target application, and batching parameters.

19. The method of claim 12 further comprising:
receiving the data by the vehicle from another vehicle having communication capabilities that are limited using a vehicle-to-vehicle (V2V) connection, wherein the vehicle has connection speeds that are sufficient for transmitting the data; and
uploading the data by the vehicle at a charging station according to the part numbers and the designated parts.

20. The method of claim 12, wherein distributing the data by splitting into the designated parts and assigning the designated parts further includes:
forming the designated parts by the vehicle using the information and directions from a databroker, where the directions factor states of charges (SOC) and remaining data transfers for the nearby vehicles accumulated by the databroker.
